(19) United States
(12) Patent Application Publication
(10) Pub. No.: US 2018/0072010 A1
(43) Pub. Date: Mar. 15, 2018

(54) PRESS SYSTEM AND CONTROL METHOD FOR PRESS SYSTEM

(71) Applicant: KOMATSU INDUSTRIES CORPORATION, Kanazawa-shi, Ishikawa (JP)

(72) Inventor: Takahiko KUROKAWA, Nonoichi-shi, Ishikawa (JP)

(73) Assignee: KOMATSU INDUSTRIES CORPORATION, Kanazawa-shi, Ishikawa (JP)

(21) Appl. No.: 15/557,859

(22) PCT Filed: Mar. 9, 2016
(86) PCT No.: PCT/JP2016/057306

§ 371 Date: Sep. 13, 2017

(30) Foreign Application Priority Data
Apr. 30, 2015 (JP) 2015-093053

(51) Int. Cl. B30B 15/14; G05B 19/25

(52) U.S. Cl. CPC B30B 15/148; G05B 19/25

(57) ABSTRACT

A press system includes: a detection unit configured to detect a press load applied for pressing a workpiece; a calculation unit configured to calculate an amount of eccentricity of a slide based on the press load detected by the detection unit; a determination unit configured to make a determination about whether the press load detected by the detection unit exceeds an allowable value of press load based on the amount of eccentricity calculated by the calculation unit; and a notification unit configured to provide notification of an abnormality based on a result of the determination by the determination unit. Accordingly, whether an abnormality is present or not is determined using an allowable value of press load based on an amount of eccentricity, and whether an eccentricity abnormality is present or not can thus be determined with high accuracy.

### TECHNICAL FIELD

The present invention relates to press systems, and particularly to press systems for pressing a workpiece.

### BACKGROUND ART

Recently, there have been demands for enhancement of the accuracy of pressed products (higher accuracy of shape and dimension) as well as for increase of the pressing speed for enhancement of the productivity.

Usually, when a process such as deep drawing or forming for example that takes a certain long time is performed with a press machine, a method is commonly executed that presses a workpiece by continuously applying a load of a predetermined value or more to the workpiece from the start to the end of the pressurization. The load applied at this time may be at least larger than a minimum load required for forming a workpiece. When a pressing process is performed, a slide is controlled so that a load of a predetermined value or more is applied continuously.

When a process that requires a large load for forming is performed on a workpiece with a high load, the press machine may make an emergency stop due to an overload abnormality.

A relevant method is disclosed for example in Japanese Patent Laying-Open No. 10-113800 (Patent Document 1). According to this method, an eccentric load is calculated, and whether an abnormality is present or not is determined based on whether the eccentric load is larger than an allowable eccentric load value or not.

### CITATION LIST

### Patent Document

PTD 1: Japanese Patent Laying-Open No. 10-113800

### SUMMARY OF INVENTION

### Technical Problem

According to the method disclosed in above-referenced Patent Document 1, the determination is made based on a predetermined value of the allowable eccentric load, and restriction is merely imposed on the maximum load value in the condition where an eccentricity occurs.

The allowable value for an actual press machine, however, varies depending on the amount of eccentricity. The determination about whether an eccentricity abnormality is present or not has not been made with high accuracy.

The present invention has been made to solve the above problem, and an object of the present invention is to provide a press system and a control method for the press system that enable a determination about whether an eccentricity abnormality is present or not to be made with high accuracy.

### Solution to Problem

A press system according to an aspect includes: a detection unit configured to detect a press load applied for pressing a workpiece; a calculation unit configured to calculate an amount of eccentricity of a slide based on the press load detected by the detection unit; a determination unit configured to make a determination about whether the press load detected by the detection unit exceeds an allowable value of press load based on the amount of eccentricity calculated by the calculation unit; and a notification unit configured to provide notification of an abnormality based on a result of the determination by the determination unit.

According to the present invention, whether an abnormality is present or not is determined using an allowable value of press load based on an amount of eccentricity determined from the detected press load, and a determination about whether an eccentricity abnormality is present or not can be made with high accuracy.

Preferably, the measurement unit is configured to measure respective press loads at a plurality of points of the slide, the calculation unit is configured to calculate an amount of eccentricity between the plurality of points of the slide based on the detected press loads, and the determination unit is configured to determine whether the respective press loads at the plurality of points of the slide detected by the detection unit exceed an allowable value of press load based on the amount of eccentricity between the plurality of points of the slide calculated by the calculation unit. The calculation of the amount of eccentricity between the plurality of points enables a determination to be made about whether an eccentricity abnormality is present or not with high accuracy.

Preferably, the notification unit is configured to output abnormality information to a display. The abnormality information is thus output to the display to enable an operator to be visually notified of the abnormality.

Preferably, the detection unit is configured to detect a press load during an operation period of slide stroke. The calculation unit is configured to calculate an amount of eccentricity of the slide based on the press load detected by the detection unit during the operation period. The determination unit is configured to determine whether the press load detected by the detection unit exceeds an allowable value of press load based on the amount of eccentricity calculated by the calculation unit during the operation period. A determination about whether an eccentricity abnormality is present or not can be made during the operation period of slide stroke.

A control method for a press system according to an aspect includes: detecting a press load applied for pressing a workpiece; calculating an amount of eccentricity of a slide based on the detected press load; making a determination about whether the detected press load exceeds an allowable value of press load based on the calculated amount of eccentricity of the slide; and providing notification of an abnormality based on a result of the determination.

According to the present invention, whether an abnormality is present or not is determined using an allowable value of press load based on an amount of eccentricity determined from the measured press load. Whether an eccentricity abnormality is present or not can thus be made with high accuracy.

### Advantageous Effects of Invention

The press system and the control method for the press system enable a determination about whether an eccentricity abnormality is present or not to be made with high accuracy.

### BRIEF DESCRIPTION OF DRAWINGS

FIG. 1 is a diagram illustrating a press machine 10 according to the present embodiment.

FIG. 2 is a block diagram showing a functional configuration of a controller 40 according to the present embodiment.

FIG. 3 is a diagram illustrating load waveforms of press loads according to the present embodiment.

FIG. 4 is a diagram illustrating how a determination is made about whether an eccentric-load abnormality is present or not in press machine 10 according to the present embodiment.

FIG. 5 is a diagram illustrating how an allowable value (threshold line L1) of the press load is set according to the present embodiment.

FIG. 6 is a diagram illustrating the number of points of press machine 10.

FIG. 7 is a flow diagram illustrating a process for determining an eccentric-load abnormality by controller 40 of press machine 10 according to the present embodiment.

### DESCRIPTION OF EMBODIMENTS

Embodiments will be described in detail with reference to the drawings. In the drawings, the same or corresponding parts are denoted by the same reference characters, and a description thereof will not be repeated.

### <Press Machine>

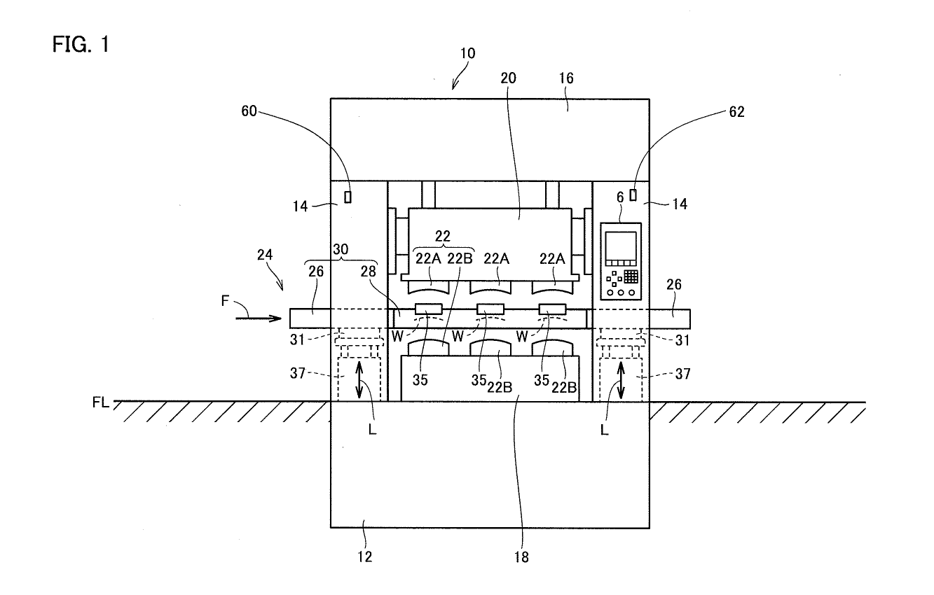

FIG. 1 is a diagram illustrating a press machine 10 according to the present embodiment.

FIG. 1 shows press machine 10 that is a transfer-type press machine as seen in front view. The press machine is given as an example and is not particularly limited to the transfer type.

A bed 12 having a rectangular shape as seen in plan view is embedded under a floor FL. On four corners of bed 12 as seen in plan view, columnar uprights 14 are erected. On these four uprights, a crown 16 is supported. A slide 20 is suspended from crown 16, and an appropriate drive mechanism in crown 16 can drive slide 20 up and down. These parts form the body of the transfer-type press.

On bed 12, a moving bolster 18 is placed. Moving bolster 18 is configured to be transportable smoothly along appropriate guide means such as rail out of the press body or into the press body. On the upper surface of moving bolster 18, a lower die 22B of a die 22 is detachably mounted for machining a workpiece W.

On the lower surface of slide 20, an upper die 22A of die 22 is detachably mounted. A given workpiece W for die 22 is positioned on lower die 22B and upper die 22A is lowered together with slide 20 to press workpiece W.

Press machine 10 is equipped with a work transport device 24 for newly feeding workpiece W to be pressed or successively feeding workpiece W to the next station.

Work transport device 24 includes a long transfer bar 30 extended in parallel with the direction in which workpiece W is transported.

In FIG. 1, workpiece W is transported from left to right and, in the direction orthogonal to this transport direction, namely the direction perpendicular to the plane of FIG. 1, a work holder 35 adapted to the type of workpiece W is detachably mounted on transfer bar 30.

Work transport device 24 including transfer bar 30 as its component has a feed drive mechanism 31 as a bar drive mechanism for which a linear motor is used, for example. Transfer bar 30 is thus driven in a feed direction F. It also has a lift-clamp drive mechanism 37. Transfer bar 30 is thus driven in each of a lift direction L and a clamp direction.

Work holder 35 is provided for each operation. Work transport device 24 is controlled to be driven such that transfer bar 30 is moved to follow a preset motion in the feed direction, the clamp direction, namely the horizontally orthogonal direction to the work feed direction, and the lift direction. Accordingly, workpiece W is transported successively to the next station and the press-formed workpiece W is transported by a feeder 120.

In the present example, the number of stations for machining workpiece W is three by way of example. The number of stations can be changed appropriately depending on the manner of machining workpiece W.

Press machine 10 includes a right load sensor 60 for the right side of slide 20 and a left load sensor 62 for the left side of slide 20.

Control panel 6 is used for entering various types of data necessary for controlling press machine 10, and includes switches and ten keys for entering data as well as a display for indicating a settings screen and data which is output from press machine 10.

As the display, a programmable display having a clear touch switch panel mounted on the front face of a graphic display such as liquid crystal display or plasma display is used.

Control panel 6 may also include a data input device for data from an external storage medium such as IC card on which data set in advance is stored, or include a communication device for transmitting/receiving data in the wireless manner or through a communication line.

### <Configuration of Controller of Press Machine 10>

Next, controller 40 of press machine 10 will be described.

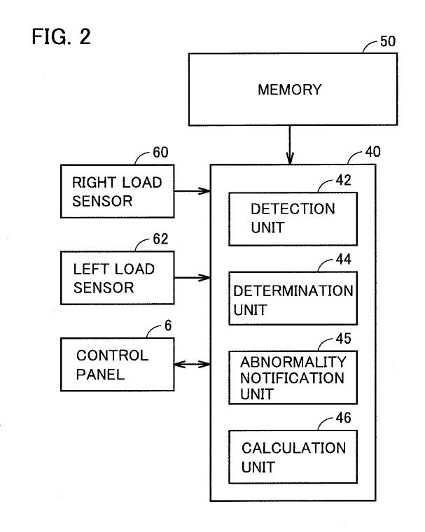

FIG. 2 is a block diagram showing a functional configuration of controller 40 according to the present embodiment.

Referring to FIG. 2, controller 40 according to the present embodiment controls the whole of press machine 10. While illustration of details in the drawing and description thereof of controller 40 are not given herein, controller 40 is configured to include a CPU, a high-speed arithmetic operation processor or the like as a main device, and configured to also include a computer device performing an arithmetic/logical operation on input data in accordance with a predetermined procedure, and an input/output interface for input/output of command current.

Controller 40 according to the present embodiment includes a detection unit 42, a determination unit 44, an abnormality notification unit 45, and a calculation unit 46.

Controller 40 is connected to a memory 50 configured as an appropriate storage medium such as ROM or RAM. In memory 50, a program(s) for controller 40 to implement various functions is(are) stored. Memory 50 is also used as a work area for execution of various arithmetic operations.

In addition to control panel 6, load sensors (right load sensor 60, left load sensor 62) are connected to controller 40. With the load sensors, controller 40 can determine the state of the press load applied by slide 20.

Detection unit 42 receives input of data from right load sensor 60 and left load sensor 62 to detect a press load applied for press working. Detection unit 42 may also receive and detect an externally given instruction to execute a predetermined process. For example, detection unit 42 may receive an instruction to stop press activation to cause press working to stop.

Calculation unit 46 calculates an amount of eccentricity of slide 20 during press working, based on the press load detected by detection unit 42.

Determination unit 44 determines whether the press load detected by detection unit 42 is larger than an allowable value of the press load based on the amount of eccentricity of slide 20 calculated by calculation unit 46. When determination unit 44 determines that the press load detected by detection unit 42 is larger than the allowable value of the press load based on the amount of eccentricity, determination unit 44 determines that a press abnormality is present. In contrast, when determination unit 44 determines that the press load detected by detection unit 42 is not larger than the allowable value of the press load based on the amount of eccentricity, determination unit 44 determines that a press abnormality is not present.

A table used for calculating the allowable value of the press load based on the amount of eccentricity is stored in advance in memory 50.

Abnormality notification unit 45 provides notification of an abnormality based on the result of the determination by determination unit 44. Specifically, based on the result of the determination by determination unit 44, abnormality notification unit 45 instructs control panel 6 to output information indicating that the press working is overload press working. Following the instruction, control panel 6 outputs the information to the display. Alternatively, control panel 6 may be configured to output an alarm. When press machine 10 is connected to an external device through a network, abnormality notification unit 45 may transmit to the external device through the network, the information indicating that an abnormality is present. A press load (eccentric load) larger than the allowable value of the press load causes cracks or breakage of the plunger or the frame, or tilting of the press.

The notification thus enables a user to easily know the abnormality of the press load (eccentric load) to thereby urge maintenance of press machine 10 or adjustment of press working to be conducted.

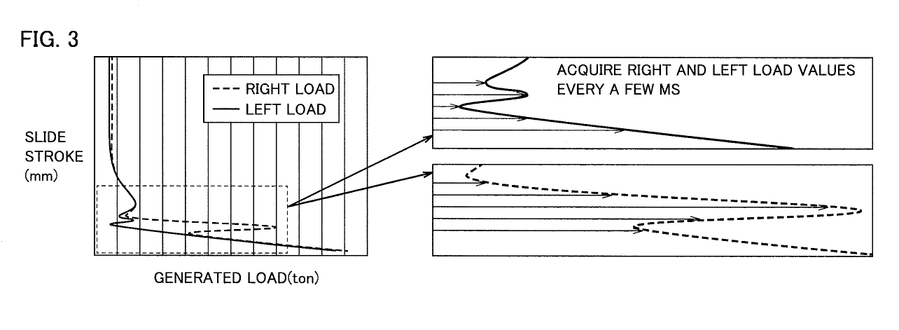

FIG. 3 is a diagram illustrating load waveforms of press loads according to the present embodiment.

FIG. 3 shows respective press loads generated with slide stroke and measured by right load sensor 60 and left load sensor 62.

In the illustrated case, the press load varies with slide stroke.

In the illustrated case, an eccentric-load abnormality occurs when the difference between the right load and the left load excessively increases during press working, by way of example.

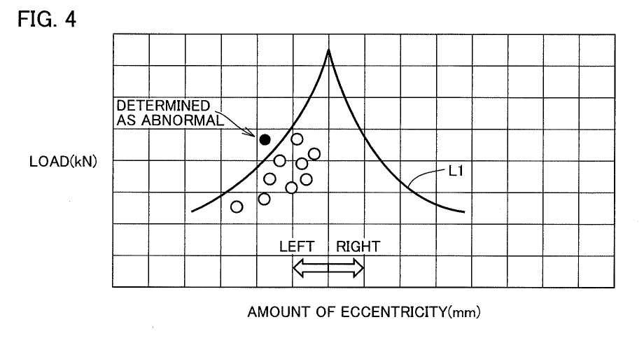

FIG. 4 is a diagram illustrating how a determination is made about whether an eccentric-load abnormality is present or not in press machine 10 according to the present embodiment.

As shown in FIG. 4, in order to detect an overload abnormality (eccentric-load abnormality) of press machine 10, press machine 10 has a protective characteristic. Specifically, an allowable value (threshold line L1) of the press load with respect to the amount of eccentricity of press machine 10 as shown in FIG. 4 is stored in memory 50 in advance. Threshold line L1 is set based on specifications of press machine 10 including conditions for press working by press machine 10 and the dimensions of slide 20, for example. Thus, if the type (size) of the press machine and/or the conditions for press working by the press machine are different ones, the shape of threshold line L1 is also a different one.

In the case shown in FIG. 4, the larger the amount of rightward/leftward eccentricity, the smaller the allowable value indicated by threshold line L1.

In the present embodiment, when the eccentric load value of press machine 10 is equal to or less than the allowable value indicated by threshold line L1, it is determined that the eccentric load of press working is a normal load and, when the eccentric load value is larger than the allowable value indicated by threshold line L1, it is determined that the eccentric load of press working is an abnormal load.

In the present embodiment, when the eccentric load value of press machine 10 exceeds the allowable value, a notification that an abnormality is present is provided. Accordingly, cracks or breakage of the plunger or the frame and tilting of the press due to an abnormal eccentric load of press working can be suppressed.

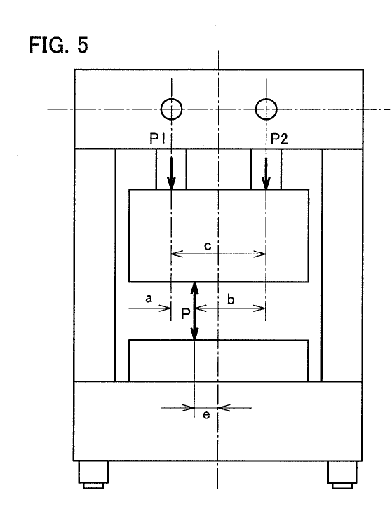

FIG. 5 is a diagram illustrating how an allowable value (threshold line L1) of the press load is set according to the present embodiment.

FIG. 5 shows an eccentric load resultant from press loads applied to two points.

Specifically, in the illustrated case, press load P1 is applied to the left point and press load P2 is applied to the right point. The distance between the points is indicated by c. In the illustrated case, eccentric load P is applied to the left side. The eccentricity from the press center is indicated by e. A counterforce against eccentric load P must not exceed a maximum capacity (Pmax/2) of the point. Eccentric load P can therefore be calculated in accordance with the following expressions, where “a” represents the eccentricity from the left point and “b” represents the eccentricity from the right point.

Eccentricities a and b are represented by the following expressions.

eccentricity a:c/2−e (1)

eccentricity b:c/2+e (2)

press load P1=P×b/c≦Pmax/2 (3)

press load P2=P×a/c≦Pmax/2 (4)

P1+P2=P (5)

Pmax is a maximum capacity of the press machine.

The above expressions are expanded into

P=cPmax/(c+2e) (6).

Namely, the allowable value of the press load can be calculated as a function of eccentricity e.

Eccentricity e is represented by the following expression: e=c×P1/P1+P2 (where P1>P2). This e can be substituted into the above expression (6) to calculate the allowable value of the press load. In the example described here, the relation P1>P2 holds. However, in the case of P2≧P1, P1 and P2 can be replaced with each other to perform the calculation in a similar manner.

The allowable value of the press load is compared with a detected press load to determine whether the detected press load is larger than the allowable value of the press load. When it is determined that the detected press load is larger than the allowable value of the press load, it is determined that the load is an abnormal eccentric load. In contrast, when it is determined that the detected press load is not larger than the allowable value of the press load, it is determined that the load is a normal eccentric load.

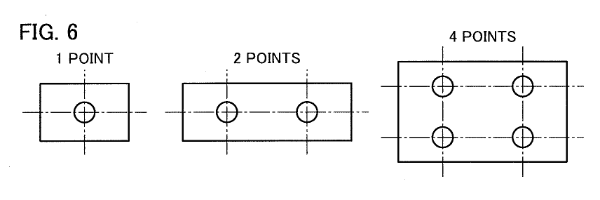

FIG. 6 is a diagram illustrating the number of points of press machine 10.

FIG. 6 shows respective cases where the number of points is one, two, and four. The larger the number of points, the higher the durability against eccentricity.

The setting of the allowable value of the press load depending on the number of points can be changed appropriately as a design change by those skilled in the art. While the above description is applied to the eccentric load with respect to the right to left direction, the determination about whether the load is a normal load or not can be made as well for the eccentric load with respect to the front to rear direction.

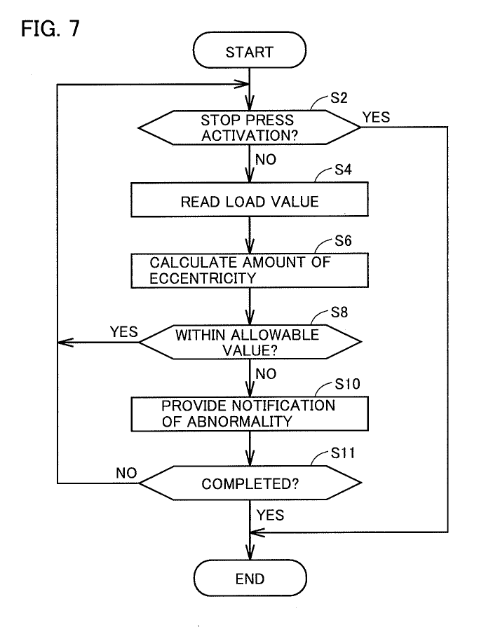

FIG. 7 is a flow diagram illustrating a process for determining an eccentric-load abnormality by controller 40 of press machine 10 according to the present embodiment.

As shown in FIG. 7, press machine 10 determines whether an instruction to stop press activation has been given or not (step S2). Detection unit 42 determines whether it has accepted an instruction to stop press activation or not.

When the instruction to stop press activation has been given in step S2 (YES in step S2), press machine 10 ends the process (END). When detection unit 42 has accepted the instruction to stop press activation, press working is stopped. In contrast, when the instruction to stop press activation has not been given in step S2 (NO in step S2), press machine 10 continues the process.

Press machine 10 reads a load value (step S4). Detection unit 42 acquires a load waveform of the press load from a load sensor.

Next, press machine 10 calculates the amount of eccentricity of the slide based on the press load (step S6). Calculation unit 46 calculates the amount of eccentricity of the slide based on the press load detected by detection unit 42.

Next, press machine 10 determines whether the press load is within an allowable value of the press load based on the calculated amount of eccentricity (step S8). Determination unit 44 acquires the allowable value of the press load based on the amount of eccentricity calculated by calculation unit 46 as described above with reference to FIG. 4 to determine whether the press load detected by detection unit 42 is within the allowable value of the press load.

In step S8, when press machine 10 determines that the press load is within the allowable value of the press load based on the calculated amount of eccentricity (YES in step S8), it returns to step S2 to continue the process.

In contrast, when press machine 10 determines in step S8 that the press load is not within the allowable value of the press load based on the calculated amount of eccentricity (NO in step S8), it provides notification of an abnormality (step S10). Determination unit 44 instructs abnormality notification unit 45 to give notification. Following the instruction from determination unit 44, abnormality notification unit 45 provides notification of an abnormality.

In the illustrated case, notification of an abnormality is provided. When the notification of an abnormality is provided, stoppage of press working may also be caused.

Next, press machine 10 determines whether the process has been completed or not (step S11). Determination unit 44 determines whether the press working process has been completed or not.

When press machine 10 determines in step S11 that the process has been completed (YES in step S11), it ends the process (END).

In contrast, when press machine 10 determines that the process continues (NO in step S11), it returns to step S2 to repeat the above-described process.

When a press load higher than the allowable value of the press load is detected, abnormality notification unit 45 provides a notification that the press load is an abnormal eccentric load. Specifically, it outputs information indicating overload abnormality (eccentric-load abnormality) of the press working to the display of control panel 6. The information displayed as shown in FIG. 4 for example may be given to indicate the position of the abnormality.

Alternatively, it may output an alarm sound so as to give to an operator a notification that press working is overload press working. It is also possible to transmit such information to an external device (management device) connected through a network to press machine 10, so that a management staff can keep track of the information.

This method makes it possible to prevent press working from being continued with an eccentric load higher than an allowable value of the press load and thereby suppress cracks or breakage of the plunger or the frame, or tilting of the press, for example.

According to this method, a load value during press working is measured to determine whether or not the load value exceeds an allowable value of the press load. A determination can therefore be made about whether an eccentric-load abnormality is present or not during press working (during slide stroke). Thus, whether an eccentric-load abnormality is present or not can be determined with high accuracy.

In the illustrated example, notification of an abnormality is provided when an eccentric load higher than an allowable value of the press load is detected. The number of times an eccentric load higher than the allowable value of the press load is detected may be counted and notification of an abnormality may be provided when the counted number exceeds a predetermined number of times. The design can be changed appropriately so as to change the predetermined number of times by those skilled in the art to an optimum number of times that enables avoidance of cracks and breakage of the plunger and the frame as well as tilting of the press, for example.

While the above description is of the case where the system is applicable to the transfer-type press machine, the system is not particularly limited to this and the system is also applicable to press machines of other types.

While the above description is of the functional characteristics of controller 40 provided in a press machine, the functional characteristics are not limited to the press machine but applicable to a press system including the press machine. For example, when the press machine is connected to an external server through a network, the functions can be performed in cooperation with a CPU of the external server. The indication on the display unit is not limited to indication on the display unit of the press machine, and may be indication on a display unit of a terminal connectable to the press machine through a network.

It should be construed that the embodiments disclosed herein are given by way of illustration in all respects, not by way of limitation. It is intended that the scope of the present invention is defined by claims, not by the description above, and encompasses all modifications and variations equivalent in meaning and scope to the claims.

### REFERENCE SIGNS LIST

6 control panel; 10 press machine; 12 bed; 14 upright; 16 crown; 18 moving bolster; 20 slide; 22 die; 22A upper die; 22B lower die; 24 work transport device; 30 transfer bar; 31 feed drive mechanism; 35 work holder; 37 clamp drive mechanism; 40 controller; 42 detection unit; 44 determination unit; 45 abnormality notification unit; 46 calculation unit; 50 memory; 60 right load sensor; 62 left load sensor

1. A press system comprising:
a detection unit configured to detect a press load applied for pressing a workpiece;
a calculation unit configured to calculate an amount of eccentricity of a slide based on the press load detected by the detection unit;
a determination unit configured to make a determination about whether the press load detected by the detection unit exceeds an allowable value of press load based on the amount of eccentricity calculated by the calculation unit; and
a notification unit configured to provide notification of an abnormality based on a result of the determination by the determination unit.

2. The press system according to claim 1, wherein
the detection unit is configured to detect respective press loads at a plurality of points of the slide,
the calculation unit is configured to calculate an amount of eccentricity between the plurality of points of the slide based on the detected press loads, and
the determination unit is configured to determine whether the respective press loads at the plurality of points of the slide detected by the detection unit exceed an allowable value of press load based on the amount of eccentricity between the plurality of points of the slide calculated by the calculation unit.

3. The press system according to claim 1, wherein
the notification unit is configured to output abnormality information to a display.

4. The press system according to claim 1, wherein
the detection unit is configured to detect a press load during an operation period of slide stroke,
the calculation unit is configured to calculate an amount of eccentricity of the slide based on the press load detected by the detection unit during the operation period, and
the determination unit is configured to determine whether the press load detected by the detection unit exceeds an allowable value of press load based on the amount of eccentricity calculated by the calculation unit during the operation period.

5. A control method for a press system, comprising:
detecting a press load applied for pressing a workpiece;
calculating an amount of eccentricity of a slide based on the detected press load;
making a determination about whether the detected press load exceeds an allowable value of press load based on the calculated amount of eccentricity of the slide; and
providing notification of an abnormality based on a result of the determination.
